(19) United States
(12) Patent Application Publication
(10) Pub. No.: US 2011/0213668 A1
(43) Pub. Date: Sep. 1, 2011

(54) METHOD FOR IDENTIFYING PROSPECTS FOR DIRECT MAIL MARKETING

(75) Inventor: Daniel R. Chaudoir, Port Washington, WI (US)

(73) Assignee: Central File, Inc., Brown Deer, WI (US)

(21) Appl. No.: 13/037,733

(22) Filed: Mar. 1, 2011

Related U.S. Application Data
(60) Provisional application No. 61/309,248, filed on Mar. 1, 2010.

(51) Int. Cl. G06Q 30/00

(52) U.S. Cl. 705/14.66; 705/14.49

(57) ABSTRACT

A method and system for developing direct mailing lists for use by businesses and other organizations are disclosed. Existing customer records from the organization or a related organization or class of organizations are obtained and sorted according to mailing delivery routes. Delivery routes having high concentrations of existing customers are identified. Additional demographic information is used to further narrow desired delivery routes to qualified delivery routes to those having target customers. Target Customers on qualified delivery routes having the highest concentration of existing customers are included on the mailing lists.

### CROSS-REFERENCE TO RELATED APPLICATIONS

This application claims priority to U.S. provisional application Ser. No. 61/309,248, filed Mar. 1, 2010, the entire contents of which is incorporated herein by reference.

### FIELD OF THE INVENTION

The subject matter disclosed herein relates generally to direct mail marketing and, in particular, to a method for identifying recipients for a direct mailing campaign.

### BACKGROUND OF THE INVENTION

Direct-mail marketing is one form of advertising companies use to advertise their products and services. It is also used by political organizations or other groups to distribute informative materials. Direct-mail marketing involves sending advertising or literature or other information to a large number of households, typically utilizing the U.S. Postal Service. In order to maximize the return on investment, companies and other organizations often seek to direct the mailings to households and/or businesses (businesses, households, and other direct mail recipients will hereafter be referred to collectively and individually as “households” for the sake of brevity) meeting certain criteria. Further savings, such as reduced postage rates, may be realized by performing a bulk mailing to an entire delivery route.

Historically, many methods have been used to identify those households most likely to be responsive to direct mail marketing. These methods often utilize predictive modeling techniques that rely on information such as distance from business, lifestyle information, income, accessibility, and many other similar factors to target specific households to receive the mailing.

Although predictive models may provide some increased effectiveness for a direct-mail advertising campaign, they are not without their disadvantages. Predictive models, by their nature, predict, or make an educated guess, as to which consumers may respond to a particular marketing campaign. While the predictive model may further identify neighborhoods, or delivery routes, with a high concentration of likely targets, a bulk mailing to the entire route still results in mailing the informative materials to many households that are not likely to be receptive targets.

Thus, it would be desirable to provide an improved method of identifying target households for direct-mail delivery. It would also be desirable to provide a method for reducing the number of non-target households which receive the mailing.

### SUMMARY OF THE INVENTION

Consistent with the foregoing, and in accordance with the subject matter as embodied and broadly described herein, a method of targeting households for direct-mail delivery is described in suitable detail to enable one of ordinary skill in the art to make and use the invention.

A method of developing direct mailing lists for a business, political or charitable organization, or other client is disclosed. Customer records from the client or possibly an organization to which the client belongs and/or from other, comparable organizations, are obtained and sorted according to postal service mailing or other carrier delivery routes. Delivery routes having high concentrations of existing customers of the client are identified as candidacy for inclusion in the direct-mail list. Additional demographic information is used to identify target customers on the identified delivery routes, hence identifying mailing routes qualified for inclusion on the direct mail-list. Qualified delivery routes having the highest concentration of existing customers and preferably also meeting requirements for reduced mailing costs are prioritized for inclusion on the mailing lists. Target customers on qualified delivery routes are included on the mailing list on the qualified delivery routes, preferably in order of mailing route priority.

According to one embodiment of the present invention, a method of generating a direct-mail list includes the steps of acquiring a plurality of target records from a database and storing each of the target records in an intermediate database according to a predetermined format. Delivery route information corresponding to each of the target records in the intermediate database is acquired from a route database and stored in the intermediate database. The number of target records located within each qualified delivery route is determined, and each qualified delivery route in which the number of target records located therein exceeds a predetermined threshold is identified. The target records for at least one qualified delivery route are sorted according to the order in which the route is delivered, and the delivery routes for which the target records are sorted are selected from the identified qualified delivery routes in which the number of target records exceeds the predetermined threshold. The sorted target records of the selected qualified delivery routes are included on the direct-mail list.

As another aspect of the invention, the delivery routes may be sorted according to a saturation percentage determined by dividing the number of existing customer records within each delivery route by the total number of households in each delivery route.

The process of generating the direct mail list may be initiated by receiving an order from a client for the direct-mail list identifying a desired number of target records. Enough sorted target records are then added to the direct-mail list to meet or exceed the desired number of target records. The target records may be households which have a history of prior interaction with the client and which meet a designated metric. The prior interaction may be the purchase or use of a particular product or service or type of product or service, or it may be an interaction with a particular political, religious, or charitable organization. The designated metric may be a financial metric such as an income level.

According to another embodiment of the invention, a system for generating a mailing list using the procedure described above is provided.

These and other objects, advantages, and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

The drawings furnished herewith illustrate a preferred construction of the present invention in which the above advantages and features are clearly disclosed as well as others which will be readily understood from the following description of the illustrated embodiment.

In the drawings:

FIG. 1 is a schematic representation of an exemplary system incorporating one embodiment of the present invention;

FIG. 2 is a flowchart illustrating one embodiment of a process according to the present invention;

FIG. 3 is a flowchart illustrating the steps of formatting customer records shown in FIG. 2;

FIG. 4 is a flowchart illustrating preferred steps of identifying target delivery routes shown in FIG. 2;

FIG. 5 is a flowchart illustrating preferred steps of obtaining demographic information shown in FIG. 2;

FIG. 6 is a flowchart illustrating preferred steps of generating a mailing list shown in FIG. 2; and

FIG. 7 is a table that illustrates a portion of an exemplary database used to identify target households according to one embodiment of the present invention.

In describing the preferred embodiments of the invention which are illustrated in the drawings, specific terminology will be resorted to for the sake of clarity. However, it is not intended that the invention be limited to the specific terms so selected and it is understood that each specific term includes all technical equivalents which operate in a similar manner to accomplish a similar purpose. For example, the word “connected,” “attached,” or terms similar thereto are often used. They are not limited to direct connection but include connection through other elements where such connection is recognized as being equivalent by those skilled in the art.

### DETAILED DESCRIPTION OF THE PREFERRED EMBODIMENTS

The various features and advantageous details of the subject matter disclosed herein are explained more fully with reference to the non-limiting embodiments described in detail in the following description.

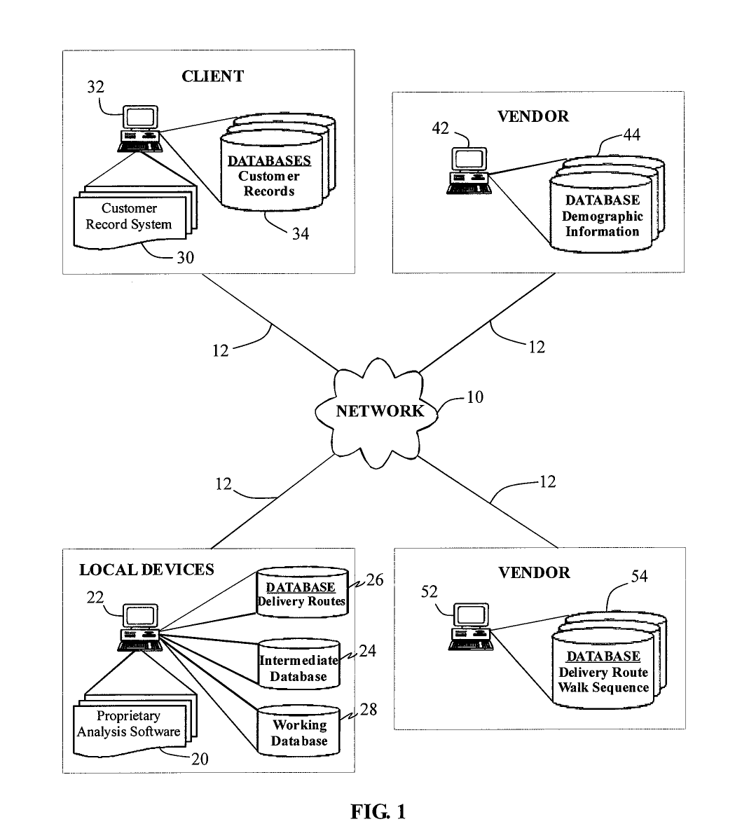

Turning initially to FIG. 1, a block diagram representation of an exemplary environment incorporating one embodiment of the present invention is illustrated. An analysis software 20 executes on a local computer 22 to generate direct mailing lists per a client's specifications. The client most typically will be a provider of a good or service advertised by direct mailing, but may be a political, religious, or charitable organization or any other group or organization desiring to deliver specific materials to particular households. Databases 24 may be saved on the local computer 22 or, optionally, stored at a remote facility, not shown, and connected to computer 22 by a network 10, or by any other direct or redirect connection capable of data transfer. The databases 24 may include information used to generate the mailing lists, such as delivery route information, or may be created to establish a working database for storing information compiled during generation of the mailing lists.

As used throughout this application, a computer, 22, 32, 42, or 52, may consist of an individual or multiple devices capable of storing data and executing commands. The devices include, but are not limited to: laptop or desktop personal computers, workstations, servers, or a combination thereof. The computers, 22, 32, 42, or 52, may run individually or be running cooperatively in a networked manner, as would be known in the art. Similarly, software applications, 20 or 30, may be a single application or multiple applications, each executing a portion of the program, and may execute entirely on a single computer or across multiple computers. Databases, 24, 34, 44, or 54, may also consist of a single or multiple databases, each containing a portion of the required data. Each database, 24, 34, 44, or 54, may exist either on a single computer 52 or across multiple computers, 22, 32, 42, or 52.

A client, which requests a mailing list, typically maintains a customer record database 34 containing information on households having prior interactions with the client. In the case of a retail business, the customers are typically persons or businesses that have previously purchased products and/or services from the business or otherwise interacted with the client. In the case of a political, religious, or charitable organization, the customers are typically persons or businesses that have donated money to or attended fundraisers for that organization. Instead of or in addition to storing a list of prior customers for the client, the database may store information on customers of businesses or organizations that are similarly situated to the client and/or of an entity composed of a group or collection of such businesses or organizations. In each case, the database contains a list of customers having a history of prior interaction of a specific type. The database may also be maintained by a third party that provides database access to the client, either on demand or in the form of a periodic delivery or transmission. The client may operate a proprietary customer record system 30 or, optionally, purchase customized or off-the-shelf database management software. The customer record system 30 may operate on a single computer 32 or be distributed across computers 32 at many stores or locations. Similarly, the customer record database 34 may be maintained within a single computer 32 or be distributed across the computers 32 at the different stores or locations. The multiple locations may be connected to one another by a network 10, such as the Internet or a direct hardware connection, via network connections 12. A distributed database 34 may be linked by the network 10 or, optionally, separate databases 34 may be maintained for each location. The client is preferably connected to a network 10 by a network connection 12 such that the proprietary analysis software 20 may access the customer database 34 remotely via network connections 12. The customer record database 34 may then be used to provide the records of targeted households to receive future mailings.

One or more vendors may be used to obtain information used to compile the mailing lists. Each source maintains a computer, 42 or 52, and at least one database, 44 or 54. The source compiles information to be stored in the database, 44 or 54, such as demographic data or delivery route information. The vendors' computers are preferably connected to the network 10 by a network connection 12 such that the proprietary analysis software 20 may interface with the vendors' computers, 42 or 52, via standard network connections 12. Optionally, databases 44 or 54 may be maintained on local computers 22 or purchased or otherwise obtained from the source and transferred from a physical storage medium, such as a CD-ROM, DVD-ROM, memory card, USB memory drive, or any other suitable storage medium, to the local computers 22.

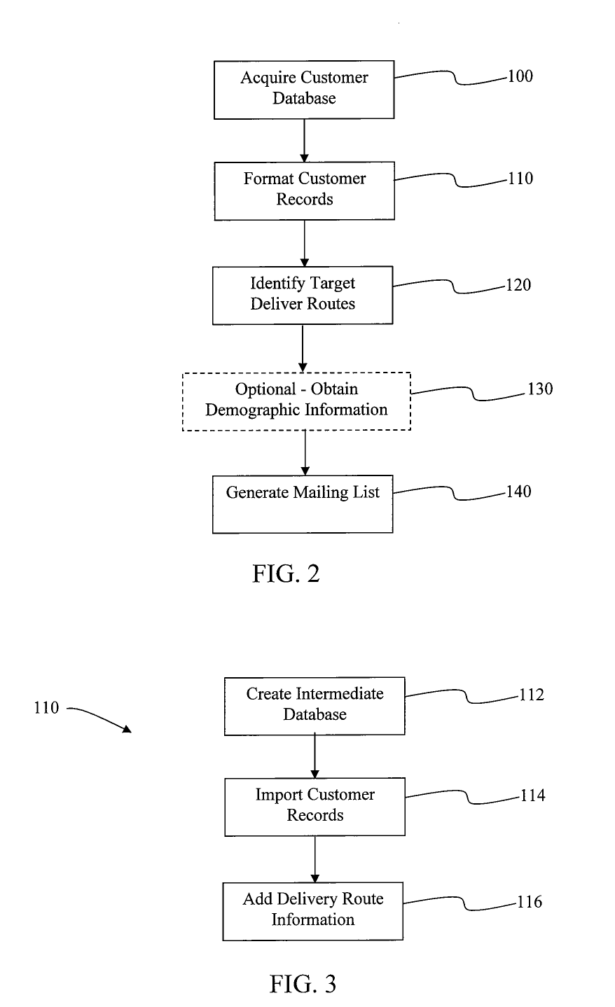

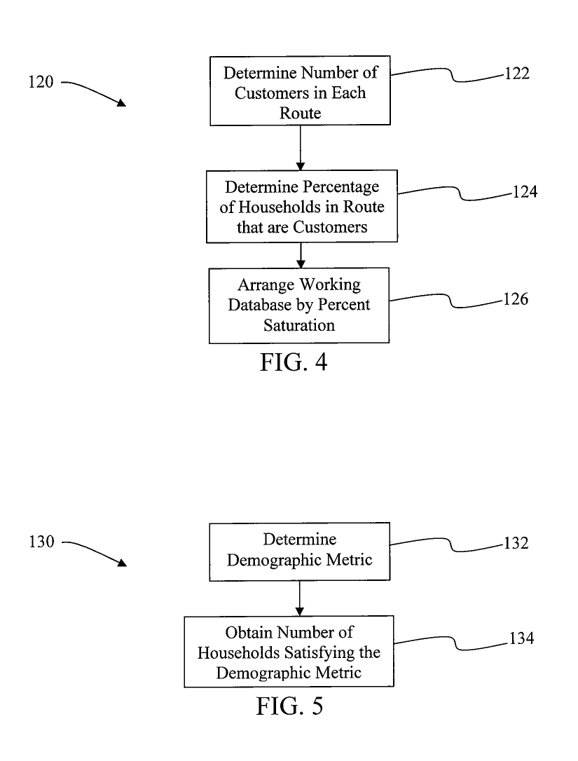

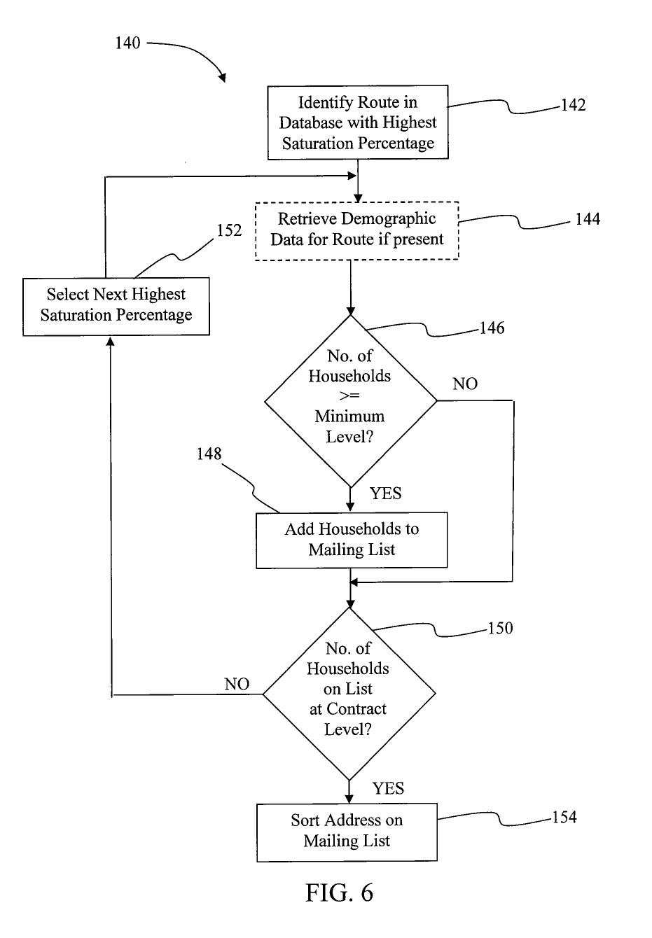

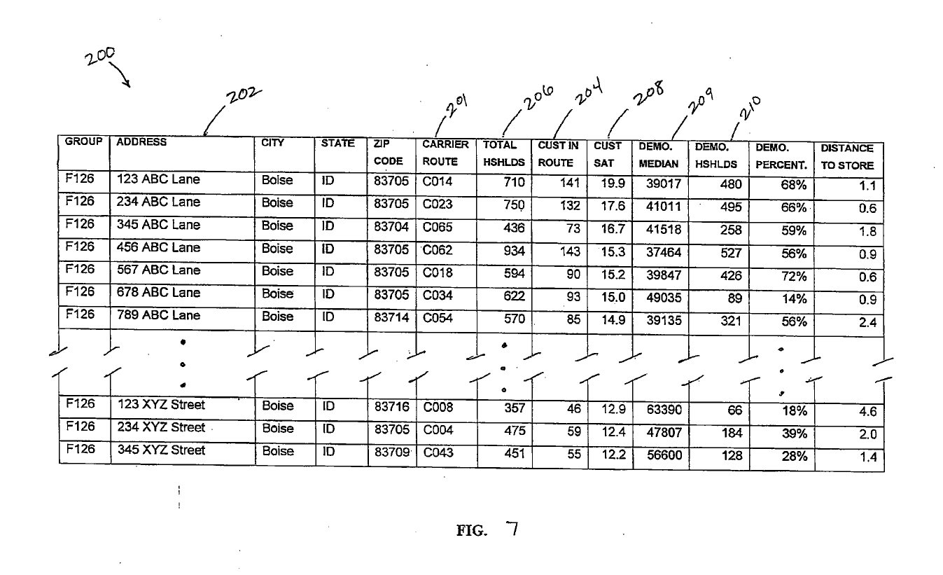

The operation of one embodiment of the method for generating a direct mailing list is illustrated generally in FIG. 2 and in more detail in FIGS. 3-6. At step 100, information from a client's customer record database 34 is acquired. The analysis software 20 connects to the client's computer 32 via a network 10 and network connections 12. The analysis software 20 interfaces with the client's customer record system 30 to retrieve customer information from a customer record database 34. Optionally, the client may create a copy of the customer record database 34, or a portion thereof, and store the copy on a physical storage medium such as a CD-ROM, DVD-ROM, memory card, USB memory drive, or any other suitable storage medium. The client may also obtain the database 34 from a third party. The client may then provide the customer record database on the storage medium for use on a local computer 22. Optionally, the client may transmit the copy to the local computer 22 via e-mail or another transmission method, uploading the copy through a web site, or by any other means that utilizes a network connection 12 between the client's computer 32 and the local computer 22.

The customer records typically must be converted into a format for use by the analysis software 20 as shown in step 110. The analysis software 20 may create an intermediate database 24, as shown in step 112, or access an existing intermediate database 24, to store the customer records locally on the computer 22. At step 114, the analysis software 20 may then copy the customer records and store them into the intermediate database 24, converting the records into a desired format.

Next, delivery route information is located for, and added to, each of the customer records in the intermediate database 24. According to one embodiment of the invention, the delivery route information includes carrier routes for the United States Postal Service (USPS), where a carrier route is a group of addresses, walked, driven, or otherwise served by a postal carrier in a day. A separate database 26 contains the delivery route information, and a separate application may execute on a computer 22 to identify delivery routes in which addresses corresponding to each customer record is physically located. At step 116, the corresponding delivery route information is copied from the delivery route database 26, appended to each of the customer records, and stored in the intermediate database 24. Optionally, the analysis software 20 may be configured to include the function of identifying and appending delivery route information to the customer records. Delivery route information for other carriers could be stored for carriers in addition to or instead of the USPS.

At step 120, an initial set of delivery routes 201 for the retailer, political campaign, or other material delivery are identified. Each delivery route 201 that includes an address 202 of at least one household from the existing customer records is included in a working database 28, an example of which is included as a table 200 in FIG. 7. At step 122, the number of existing customers 206 included in each delivery route 201 is determined. The software 20 then determines the total number of addresses 206 in each delivery route. At step 124, a saturation percentage 208 is calculated by dividing the number of existing customers 204 in each delivery route 201 by the total number of addresses 206 in that route 201. The number of existing customers 204, the total number of addresses 206, and the saturation percentage 208 for each delivery route 201 are all stored in the working database 28 and, as shown in step 126, arranged according to the saturation percentage 208. Thus, the initial set of delivery routes 201 identified by the software 20 includes only those routes containing customers that have historically had transactions with the client, ranked from highest to lowest on a percentage basis.

At step 130, demographic information relating to the delivery routes 201 contained within the working database 28 is obtained in order to identify target households in the identified delivery routes 201. The working database 28 may, for example, be forwarded to a vendor, or a list broker, that maintains one or more databases 44 containing demographic information. The working database 28 may be forwarded from a local computer 22 to the vendor's computer 42 across the network 10 and network connections 12. Optionally, the working database 28 may be transferred by storing a copy on a physical storage medium and sending the storage medium to the vendor. In step 132, desired demographic metrics for targets of the promotional campaign are determined. For example, certain businesses may prefer homes with a combined household income below a specific amount, for example $50,000 per year. Other businesses may prefer homes with a combined household income above a specific amount. Optionally, other criteria such as renter, owner, ethnicity, education level, and any other demographic indicator maintained in the database 44, or a combination thereof may be selected. The vendor then identifies the number of households 210 within each qualified delivery route 201 in the working database 28 that satisfy the selected demographic metric and, thus, that are considered target households. The number of target households 210 meeting the demographic metric is then appended to the working database 28. The working database 28 may then be returned to the local computer 22. Optionally, the local computer 22 may include a demographic database 44 from which data may be obtained. In yet another embodiment, the vendor may provide raw demographic data 209, for example, the household income of households in a delivery route, and the software 20 may identify the number of households 210 that satisfy the desired demographic metric.

Having identified those qualified delivery routes 201 that have historically produced customers and that have households in them meting one or more desired demographic metrics, the targeted direct mailing list may be generated, as shown at step 140. First, at step 142, the working database 28 is accessed beginning with the qualified delivery route 201 having the highest saturation percentage 208. The demographic information associated with that delivery route 201 is also retrieved from the working database 28, as shown in step 144. As mentioned above, delivery routes having existing customer households and target households qualify for inclusion on the direct mail list. At step 146, the number of target households 210 meeting the desired demographic metric in each qualified delivery route 201 is compared against a predetermined minimum number of households. For example, the predetermined minimum level may be selected to correspond to the minimum number of households required in a carrier route to utilize a specific postage rate. The USPS sets different postage rates for different methods of mailing. For example, sending mail to selected households in a carrier route or all of the households in a carrier route results in different postal rates. A mailing can qualify for a still lower rate, known as the “carrier route walk sequence high density rate”, if the mailing is made to at least a minimum number (presently equal to 125) households on the route and is presorted in the order that mail is delivered on that route.

If the number of target households 210 within a qualified delivery route 201 is equal to or exceeds the predetermined minimum level, then each of the target households on that qualified delivery route is added to the mailing list of target households, as shown at step 148. At step 150, the number of target households on the mailing list is compared against a contracted or otherwise designated number of target households. Once the number of target households in the lot reaches a designated number of households, the direct marketing mailing list is complete. If additional households are needed to meet the contracted or designated minimum, the software 20 moves to the qualified delivery route 201 having the next highest saturation percentage 288, per step 152, and the number total number of target households 210 is again compared to the predetermined minimum level.

According to the final step 154, the addresses of those target households included on the mailing list may then be sorted according to the order in which they are delivered on the qualified delivery route in step 154 in order to take advantage of the carrier route walk sequence density postage rate. The mailing list may either be sent to a vendor to perform the sorting or, optionally, the software 20 may be configured to sort the addresses on the mailing list. Thus, only those target households that exist in delivery routes that have historically provided customers to the client and that meet specified demographic metrics are included on the marketing mailing list.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

We claim:

1. A method of generating a direct-mail list, comprising the steps of:
acquiring records identifying a plurality of existing customers from a database;
using a computer,
comparing the customer records to a database containing delivery route information to identify potential delivery routes containing households of existing customers,
identifying qualified delivery routes by identifying delivery routes that contain both existing customer households and target households that meet a designated metric; and
including the target households in at least some of the qualified delivery routes on the direct-mail list.

2. The method of claim 1, further comprising determining the number of target households contained in each qualified delivery route.

3. The method of claim 2, further comprising sorting, from highest to lowest, the qualified delivery routes in the order of the number target households on each qualified delivery route.

4. The method of claim 1, wherein the method further comprises the steps of sorting the identified delivery routes according to a saturation percentage determined by dividing the number of existing customer households within each identified delivery route by the total number of households in each delivery route.

5. The method of claim 4, further comprising prioritizing identified delivery routes in the order of increasing saturation percentage.

6. The method of claim 1, further comprising restricting the qualified delivery routes on the directly mail lists to those having a sufficient number of target households to achieve carrier route walk sequence high density rate for each of those delivery routes.

7. The method of claim 1, further comprising:
an initial step of receiving an order from a client for the direct-mail list, the order identifying a desired number of target households; and
a final step of adding enough sorted target households on the direct-mail list to meet or exceed the desired number of target households.

8. The method of claim 1, wherein the designated metric is a designated financial demographic.

9. A system for generating a mailing list, comprising:
at least one database containing records designating delivery routes in which households of existing customers are located; and
a computer executing a program performing the steps of:
identifying qualified delivery routes by identifying designated delivery routes having target households meeting a designated metric, and
including the target household in at least some of the qualified delivery routes on the direct-mail list.

10. The system of claim 9, wherein the databases are stored on a plurality of computers connected via a network.

11. The system of claim 9, wherein at least one of the plurality of computers is located remotely from the other computers and the network is the Internet.
